(19) United States
(12) Patent Application Publication
(10) Pub. No.: US 2013/0128596 A1
(43) Pub. Date: May 23, 2013

(54) LED BULB

(71) Applicants: YING-CHIEH LU, Chu-Nan (TW); KUO-FENG CHIANG, Chu-Nan (TW); HSIN-FEI HUANG, Chu-Nan (TW); ZHENG-JAY HUANG, Chu-Nan (TW); CHIH-MING LAI, Chu-Nan (TW)

(72) Inventors: YING-CHIEH LU, Chu-Nan (TW); KUO-FENG CHIANG, Chu-Nan (TW); HSIN-FEI HUANG, Chu-Nan (TW); ZHENG-JAY HUANG, Chu-Nan (TW); CHIH-MING LAI, Chu-Nan (TW)

(73) Assignee: FOXSEMICON INTEGRATED TECHNOLOGY, INC., Chu-Nan (TW)

(21) Appl. No.: 13/300,659

(22) Filed: Nov. 21, 2011

(51) Int. Cl. F21V 21/00; F21V 29/00

(52) U.S. Cl. 362/382

(57) ABSTRACT

An LED bulb includes a connector for electrically connecting with a power supply, a heat sink disposed on the connector, and an LED mounted the heat sink. The heat sink has a first face and a second face opposite to the first face. The LED is attached on a first face of the base. The heat sink defines a plurality of through tunnels extending through the heat sink from the first face to the second face thereof.

### BACKGROUND

1. Technical Field

The disclosure relates to LED (light emitting diode) bulbs for illumination purpose and, more particularly, relates to an improved LED bulb having a good heat dissipation.

2. Description of Related Art

An LED bulb is a type of solid-state lighting that utilizes LED as a light source for indoor or outdoor illumination. An LED is a device for transferring electricity to light by using a theory that, if a current is made to flow in a forward direction through a junction region comprising two different semiconductors, electrons and holes are coupled at the junction region to generate a light beam. The LED has an advantage that it is resistant to shock, and has an almost eternal lifetime under a specific condition; thus, the LED bulb is intended to be a cost-effective yet high quality illumination device.

An LED bulb generally requires a plurality of LEDs mostly driven at the same time, which results in a rapid rise in operating temperature of the LEDs. However, since the bulb lacks effective heat dissipation mechanisms, continuous operation of the LED bulb can cause overheat of the LED, resulting in flickering or even malfunction of the LED.

What is needed, therefore, is an improved LED bulb which can overcome the above problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 shows a cross sectional view of an assembled view of an LED bulb in accordance with a first embodiment of the disclosure.

FIG. 2 shows a perspective view of a heat sink of the LED bulb of FIG. 1.

FIG. 3 shows a cross sectional view of an assembled view of an LED bulb in accordance with a second embodiment of the disclosure.

FIG. 4 shows a perspective view of a heat sink of the LED bulb of FIG. 3.

FIG. 5 shows a cross sectional view of an assembled view of an LED bulb in accordance with a third embodiment of the disclosure.

### DETAILED DESCRIPTION

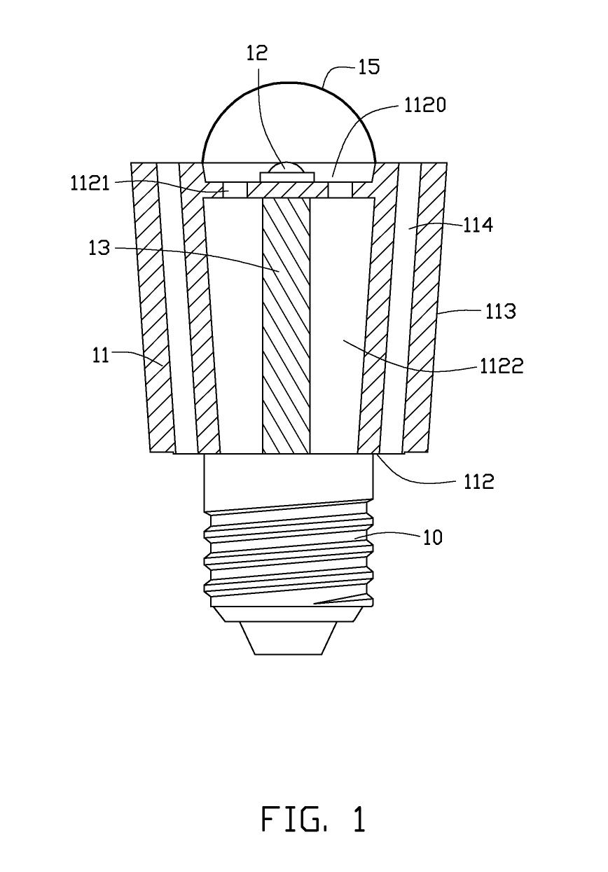

Referring to FIG. 1, a light emitting diode (LED) bulb in accordance with a first embodiment of the disclosure is illustrated. The LED bulb comprises a connector 10, a heat sink 11 disposed on the connector 10, an LED 12 mounted on the heat sink 11, and an envelope 15 secured to the heat sink 11 and covering the LED 12. The connector 10 is electrically connected with a power supply. The connector 10 is a standard cap which can be suited with conventional lamp sockets.

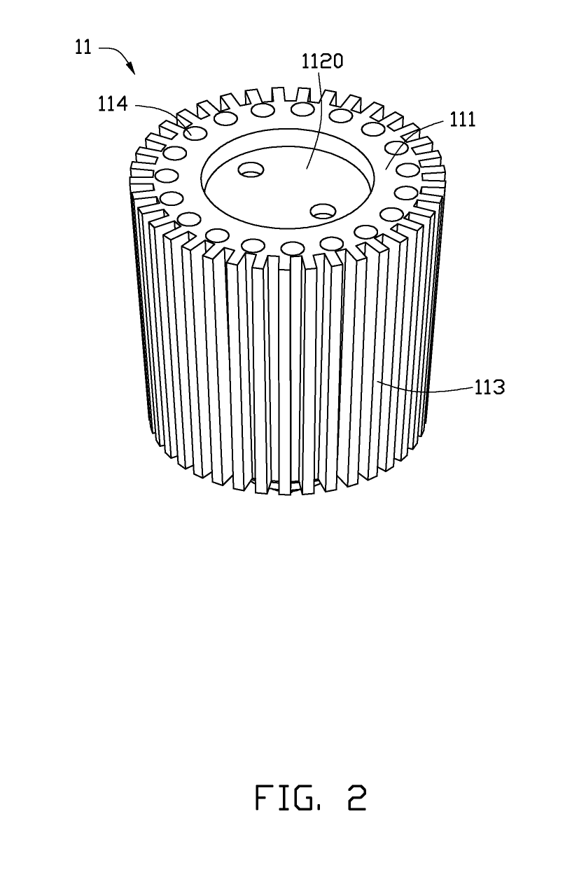

Referring to FIG. 2 also, the heat sink 11 is integrally made of aluminum-magnesium alloy or ceramic with good heat conductivity. The ceramic is made from materials selected from alumina, silicate, oxide, carbide, nitride, sulfide and boride. The heat sink 11 comprises a columnar body 112, and a plurality of fins 113 integrally extending outwardly from an outer circumference of the body 112. A top face of the body 112 is concaved downwardly to form a depression 1120. The depression 1120 has a flat face on which the LED 12 is attached. Two spaced through holes 1121 are defined in the flat face of the depression 1120 for extension of electrical wires therethrough to electrically connect with the LED 12. The columnar body 112 defines a cavity 1122 therein for accommodating a driving module 13, which is electrically connected to the connector 10 and the LED 12. The driving module 13 is configured for providing driving voltage for the LED 12. The fins 113 are spaced from each other.

The fins 113 are arranged radially relative to the body 112. A passage is defined between every two neighboring fins 113.

A plurality of through tunnels 114 are defined in the body 112. Each of the through tunnels 114 extends through the body 112 and has two openings at the top face and a bottom face of the body 112, respectively. The through tunnels 114 are arranged along a circumferential direction of the body 112 of the heat sink 11. The through tunnels 114 are located adjacent to an outer periphery of the body 112 and close to the fins 113. The openings of the through tunnels 114 which are located at the top face of the body 112 surround the depression 1120. Each of the openings of the through tunnels 114 is located corresponding to the passage between two adjacent fins 113.

The LED 12 is thermally attached on the flat face of the depression 1120 of the base 12. In the embodiment of the present disclosure, a circuit is formed on the flat face of the depression 1120 of the body 112, and the LED 12 is electrically mounted on the circuit. It is understood that the number of the LED 12 is not limited to the present embodiment, the number of the LED 12 can also be two, three, etc..

The LED bulb further comprises an envelope 15 disposed on a top of the heat sink 11 and correspondingly covering the LED 12. The envelope 15 is integrally formed of a transparent or semitransparent material such as glass, resin or plastic. The envelope 15 is fitly engaged with the depression 1120 of the heat sink 10, whereby the envelope 15 hermetically cooperates with the body 112 to enclose the LED 12 therein for increasing the sealing performance of the LED bulb. Furthermore, the envelope 15 can function to modulate the light generated by the LED 12 to have a desired pattern.

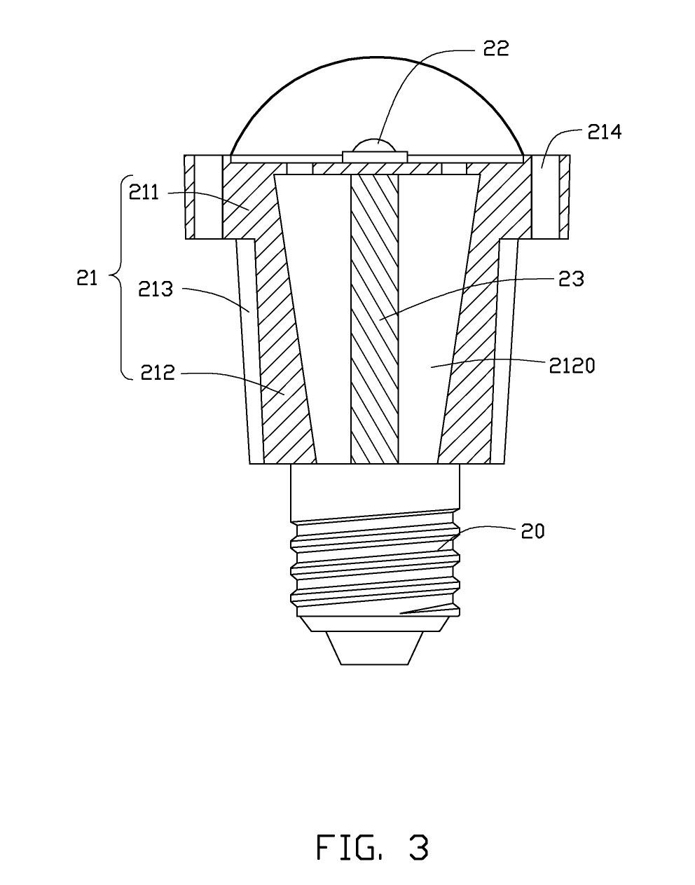

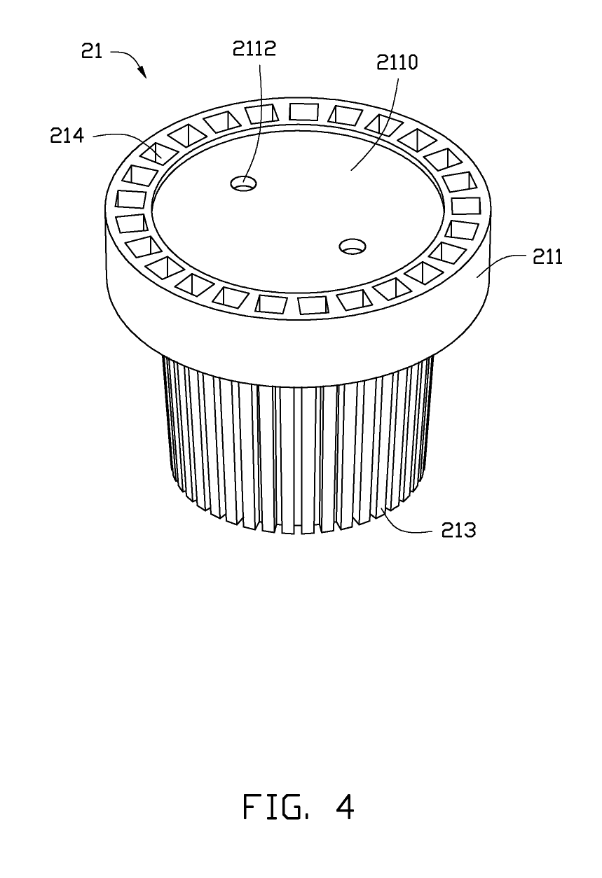

Referring to FIGS. 3 and 4 also, an LED bulb in a second embodiment of this disclosure is shown. The LED bulb comprises a connector 20, a heat sink 21 disposed on the connector 20, and an LED 22 mounted on the heat sink 21. The heat sink 21 comprises a circular base 211, a tube 212 integrally extending downwardly from a bottom of the base 211, and a plurality of fins 213 integrally extending outwardly from an outer circumference of the tube 212. A top face of the base 211 is concaved downwardly to form a depression 2110. The depression 2110 has a flat face on which the LED 22 is attached. Two spaced through holes 2112 are defined in the flat face of the depression 2110 for extension of electrical wires therethrough to electrically connect with the LED 22. The tube 212 extends perpendicularly and downwardly from a center of the bottom of the base 211. A diameter of the tube 212 is less than that of the base 211. The fins 213 are spaced from each other. The fins 213 are arranged radially relative to the tube 212. A passage is defined between every two neighboring fins 213. The fins 213 directly connect with the bottom of the base 211. The tube 212 defines a cavity 2120 at a center thereof, for accommodating a driving module 23 therein. A distal end of the tube 212 is engaged with the connector 20.

A plurality of through tunnels 214 are defined in the base 211. Each of the through tunnels 214 extends through the base 211 and has two openings at the top face and the bottom face of the base 211, respectively. The through tunnels 214 are arranged radially relative to the depression 2110 and the tube 212. The openings of the through tunnels 214 which are located at the top face of the base 211 surround the depression 2110. The openings of the through tunnels 214 which are located at the bottom face of the base 211 surround the tube 212. Each of the openings of the through tunnels 214, which is located at the bottom face of the base 211, is located corresponding to the passage between two adjacent fins 213. The through tunnels 214 are located adjacent an outer periphery of the base 211. Each through tunnel 214 is oriented vertically.

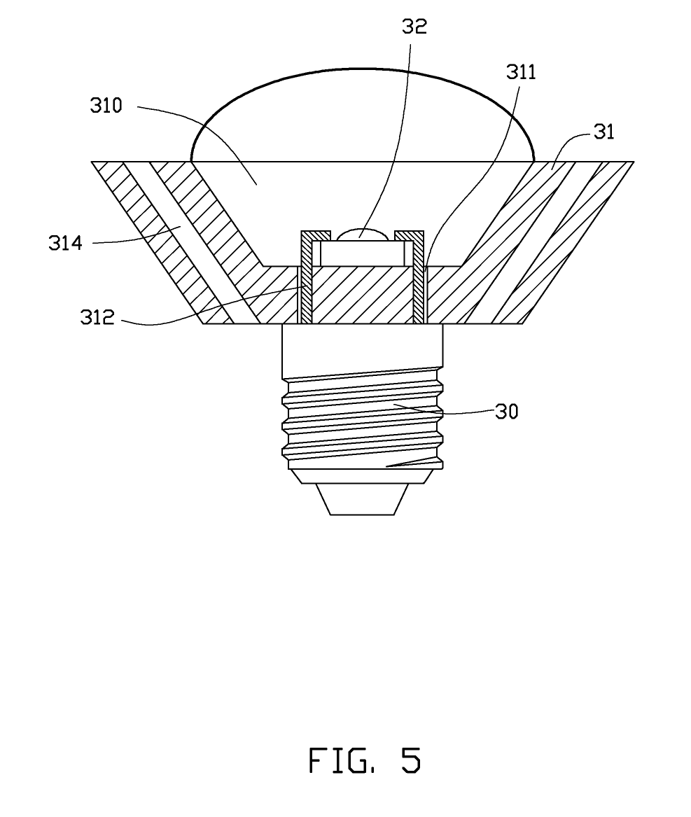

Referring to FIG. 5 also, an LED bulb in a third embodiment of this disclosure is shown. The LED bulb comprises a connector 30, a heat sink 31 disposed on the connector 30, and an LED 32 mounted on the heat sink 31. The heat sink 31 has a configuration like an inverted cone. A top face of the heat sink 31 is concaved downwardly to form a depression 310. The depression 310 has a flat face on which the LED 32 is attached. Two spaced through holes 311 are defined in the flat face of the depression 310 for extension of electrical wires 312 therethrough to electrically connect with the LED 32.

A plurality of through tunnels 314 are defined in the heat sink 31. Each of the through tunnels 314 extends through the heat sink 31 and has two openings at the top face and a bottom face of the heat sink 31, respectively. The through tunnels 314 are arranged radially relative to the depression 310 of the heat sink 31. The through tunnels 314 are located adjacent an outer periphery of the heat sink 31. Each through tunnel 314 is oriented inclinedly towards the connector 30 along a top-to-bottom direction of the LED bulb.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED bulb comprising:
a connector for being electrically connected to a power supply;
a heat sink disposed on the connector, the heat sink having a first face and a second face opposite to the first face and adjacent to the connector; and
at least an LED mounted on the first face of the heat sink;
wherein the heat sink defines a plurality of through tunnels extending through the heat sink from the first face to the second face of the heat sink.

2. The LED bulb as described in claim 1, wherein the heat sink comprises a body, and a plurality of fins extending outwardly from an outer circumference of the body.

3. The LED bulb as described in claim 2, wherein the through tunnels extend through the body of the heat sink.

4. The LED bulb as described in claim 3, wherein the fins are spaced from each other, and an airflow passage is defined between every two adjacent fins.

5. The LED bulb as described in claim 4, wherein each of the through tunnels is located adjacent to a corresponding passage.

6. The LED bulb as described in claim 1, wherein the through tunnels are spaced from each other.

7. The LED bulb as described in claim 1, wherein the through tunnels are arranged along a circumferential direction of the heat sink.

8. The LED bulb as described in claim 1, wherein the heat sink is integrally made of ceramic.

9. The LED bulb as described in claim 8, wherein the ceramic is made a material selected from a group consisting of alumina, silicate, oxide, carbide, nitride, sulfide and boride.

10. The LED bulb as described in claim 1, wherein the first face of the heat sink is concaved downwardly to form a depression, and the depression has a flat face on which the at least an LED is attached.

11. An LED bulb comprising:
a connector for being electrically connected to a power supply;
a heat sink disposed on the connector, the heat sink comprising a base, a tube extending downwardly from a first face of the base to be connected to the connector, and a plurality of fins extending outwardly from an outer circumference of the tube; and
at least an LED mounted a second face of the base;
wherein the base defines a plurality of through tunnels extending through the base from the first face to the second face of the base.

12. The LED bulb as described in claim 11, wherein the through tunnels are located adjacent to an outer periphery of the base.

13. The LED bulb as described in claim 11, wherein the through tunnels are spaced from each other.

14. The LED bulb as described in claim 11, wherein each of the through tunnels extends through the base and has two openings at the first face and the second face of the base, respectively.

15. The LED bulb as described in claim 14, wherein the second face of the heat sink is concaved downwardly to form a depression, and the depression has a flat face on which the at least an LED is attached.

16. The LED bulb as described in claim 15, wherein the openings of the through tunnels which are located at the second face of the base surround the depression.

17. The LED bulb as described in claim 15, wherein the openings of the through tunnels which are located at the first face of the base surround the tube.

18. The LED bulb as described in claim 11, wherein the fins directly connect with the first face of the base.
